(19) United States
(12) Patent Application Publication
(10) Pub. No.: US 2006/0026519 A1
(43) Pub. Date: Feb. 2, 2006

(54) Providing programmatic access to an application's user interface elements

(76) Inventors: Alexander Vaindiner, Or-Akiva (IL); Vladen Loukiantchenko, Modiin (IL); Ilan Poreh, Wayland, MA (US)

Correspondence Address: PEARL COHEN ZEDEK, LLP, 10 ROCKEFELLER PLAZA, SUITE 1001, NEW YORK, NY, 10020, US

(21) Appl. No.: 11/170,732

(22) Filed: Jun. 30, 2005

Related U.S. Application Data
(60) Provisional application No. 60/584,152, filed on Jul. 1, 2004.

(51) Int. Cl. G06F 3/00

(52) U.S. Cl. 715/700

(57) ABSTRACT

The invention describes a principal possibility and structural organization of turning any application that utilizes graphical user interface into programmatic accessible object model. This conversion is non-invasive and independent of the underlying object model of the application. Moreover, this approach allows extended functionality, user interface and interoperability of existing applications.

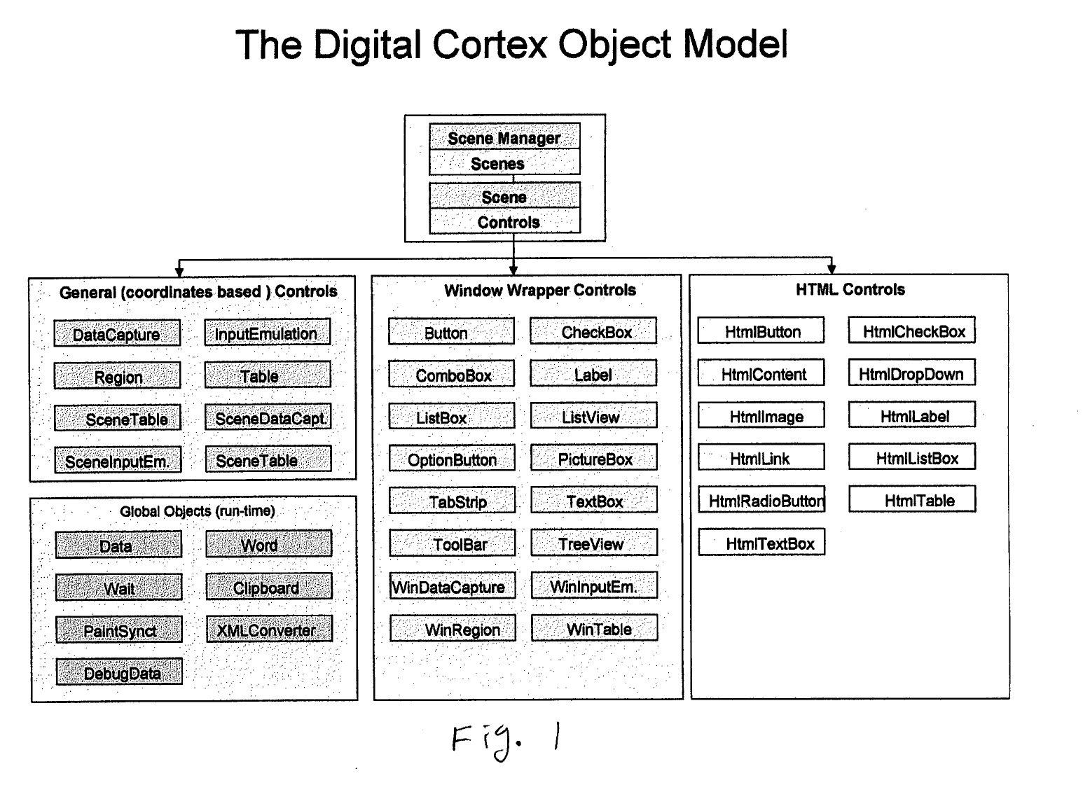

### CROSS-REFERENCE TO ATTACHED APPENDICES

Appendices A-D, which are part of the present disclosure, are incorporated herein by reference in their entirety.

### COPYRIGHT/TRADEMARK NOTICE

At least one portion of this disclosure contains material, which is subject to copyright/trademark protection. The copyright/trademark owner has no objection to the facsimile reproduction by anyone of the patent document or the patent disclosure, as it appears in the U.S. Patent and Trademark Office patent files or records, but otherwise reserves all copyright/trademark rights whatsoever.

### BACKGROUND

1. Field of the Invention

The present solution (also referred to as Digital Cortex®) relates generally to software development and more particularly, to a set of tools and services that non-invasively expose an application's user interface (UI) objects to further allow said objects to be visually selected and programmatically accessed within a single object model (framework) independent of the underlying object model of the exposed application.

2. Description of Related Art

Information is predicted to be “the oil of the 21st century,” the fundamental resource underlying virtually all economic activity. As a consequence, effective use of information will be a key source of competitive advantage.

In order to maximize both the value of their information and their ability to use it, the business users in an organization need three things:
1. The ability to get the information they need, when they need it, wherever they are, and on whatever device they are using, whether PC, palmtop or wireless phone;
2. The ability to make all of their information work together, irrespective of its location, type or format; and
3. The ability to automate as much of their work as possible including higher value-added work such as the synthesis and association of data from a variety of sources into useful information.

Line-of-business (LOB) managers and IT managers who are charged with addressing these issues within the organization have additional requirements:
1. Leverage existing assets, including software and staff;
2. High return on investment (ROI), ideally at a low cost;
3. Rapid time-to-benefit; and
4. A robust, scalable solution.

Until now, business users have been thwarted both by barriers between different computing platforms and, even more frustratingly, by the barriers between the applications through which they work with information.

Today, information is isolated in pockets scattered throughout the enterprise and throughout the world. Systems—even those within a single organization—have been developed over time to perform specific functions, but have rarely been designed with a single, unified view of the information needs of the whole organization in mind. Another dimension of complexity is the increasing need for businesses to work in close collaboration with customers, partners, and suppliers, which are often prevented by the very architecture of current information systems from sharing the information needed to coordinate their business processes. Added to all of this is the fact that an organization's information needs tend to change over time—sometimes overnight—requiring the organization to modify its systems quickly if it is to maintain a competitive edge.

The inability of current information systems to share information and functionality in a useful form is the fundamental impediment to free flow of information within and between organizations.

Addressing this inability, known as the interoperability problem, is both the largest single problem in computing and one of the greatest strategic challenges in business today. Companies spend tens of billions of dollars every year attempting to solve the interoperability problem, an amount that is projected to grow rapidly as integration of existing business software systems with the Web and with the systems of customers, partners and suppliers becomes an increasingly business-critical issue.

The basic problem is that information is only really usable within the applications that contain it, both because most applications use proprietary file formats and because the business logic embedded within applications provides the context that gives data meaning. Complicating the problem is the fact that applications are isolated from each other. They cannot share information unless they have been designed and coded to do so, and most have not. Developers bridge the gaps between applications by writing additional “integration” code. Users bridge the gaps with their ability to perceive, remember and synthesize information from disparate sources. Computers have lacked a similar ability to “see” or “remember” information in a single, universal generic form, until today.

Over the years, a number of solutions to interoperability problems have been presented. Indeed, an entirely new category of software has been created to address the interoperability problem in large enterprises: the software-only enterprise application integration (EAI) portion of the overall dollars spent on integration/interoperability issues is estimated to be over $1 billion and growing very rapidly. However, the vast majority of solutions to the interoperability problems plaguing businesses of all sizes and kinds have depended upon custom coding by systems integrators or IT departments, or upon manual work-arounds that adapt business processes to the constraints imposed by current information system architectures.

There are two major types of interoperability problems, one caused by the failure of hardware or software platforms—such as machine types, operating systems, or communications protocols—to interoperate, the other caused by the inability of different applications—including those on the same platform or even individual machines—to interoperate. Standardized communication protocols, such as TCP/IP and cross-platform languages, such as Java, have somewhat mitigated the burdens created by hardware and operating system heterogeneity, albeit while adding an additional layer of complexity to the IT infrastructure. Standardized data formats, including ASCII text files, HTML web pages or XML documents take limited steps toward allowing applications to exchange data in a meaningful fashion.

The source of the inability of most applications to easily interoperate with each other is their fundamental architecture. Applications are typically purchased or developed to meet a particular business need and are optimized to meet that need or to perform a certain function considered on a stand-alone basis. An application development team, whether working for an independent software vendor, a system integrator, or an in-house IT department, does its best to build a system for the task at hand within the resource constraints it has to deal with. Choices of programming models, interfaces, languages, file types, or data structures are driven by the requirements of the task at hand—including budgetary restraints rather than being based on any holistic, overarching vision of the corporate information system

Indeed, in many enterprises, there is such a jumble of differing hardware and software platforms, applications, and even corporate and departmental IT organizations that no one individual or group has a clear view of either the overall needs—or a complete inventory of all of the systems, programming models, interfaces, applications, and data structures—within the entire organization. Compounding the problem are legacy applications that have been modified over time with insufficient or no documentation. Add in the dramatic changes brought about by shifting business strategies and corporate structures (including those resulting from mergers, acquisitions, or divestitures), rapidly evolving technologies, the complexities of current interoperability options, and shifts in customer, partner and supplier relationships, and it is clear that not only are the technical and organizational roots of the interoperability problem unlikely to be eliminated in any conceivable near future, eliminating them may, in fact, be impossible.

Were the pain of the interoperability problem borne only by overworked IT staffs, it is unlikely that companies would be spending the many billions of dollars to solve it that they currently do. However, the more profound impact of the interoperability problem is not on IT, but on the overall productivity of the enterprise itself.

Information systems support business processes. Increasingly, business processes are spanning multiple departments within an organization and are even crossing enterprise boundaries as companies become more tightly enmeshed with their customers, partners and suppliers. Organizations continue to purchase best-of-breed applications to address specific departmental needs, even when those applications do not provide pre-built adaptors to other applications in use within the organization. The traditional isolation of information systems by functional organization (finance, sales, marketing, engineering) works against an IT department's ability to support cross-functional business processes, much less inter-enterprise information exchanges. The business consequence is that processes that would ideally be made more efficient and far less costly through automation can only be performed with significant human involvement and often-elaborate manual work-arounds, such as re-keying information provided by one system into another.

Unfortunately, these business problems are only going to become more intractable with the continuing pressure on companies to tighten relationships with their supply chains, the requirement from customers to expose internal information such as order status or inventory levels, and the across-the-board drive to eliminate latencies from every system and process in the quest to create organizations capable of reacting in real-time. While many dot-com companies proved to be unsustainable in the absence of near-constant financial transfusions from over-eager venture capitalists and a bedazzled public market, they did succeed in raising expectations around 24/7 availability of web-based, easy-to-use access to business processes including transactions, support, and customer feedback. That many dot-com organizations were unable to link slick front-end systems to the industrial-strength back-ends that support many of their more established “old economy” competitors has in no way reduced pressure on organizations to make things work from the other direction and extend and expose their internal systems to their customers, partners, suppliers, and even employees in the relentless pursuit of lower costs and better service. But before these systems can face the world, they must first learn to “talk” to each other and support the kinds of complex, cross-functional business processes (such as placing, paying for, and tracking orders) that are the essence of a business.

There is a wide range of solutions to the interoperability problem, from point-to-point integrations of particular systems, to monolithic enterprise resource planning (ERP) and customer relationship management (CRM) solutions intended to run every business process, to pre-built connectors, and adaptors, to implementation of complex middleware systems to tie together existing systems and provide a platform for adding new ones as needs change in the future.

While the “rip and replace” ERP/CRM approach was all the rage a few years ago. EAI is increasingly a preferred systemic solution to the interoperability problem, primarily because it enables an organization to leverage its investments in best-of-breed applications, including the costs of software, customizations, and training. However, the great majority of interoperability problems are addressed either through tactical solutions, often hand-coded, or through merely suffering with systems that do not work well together and cannot seamlessly support complex business processes.

Most integration solutions that incorporate custom coding tend to be costly, complex, time-consuming, and limited to point-to-point solutions. Integration projects that exceed six months often fail because the development resources assigned to those projects tend to be re-deployed to other projects, prior to the completion of the integration project.

There are four major integration methodologies:
1. Data Level Integration
2. Logic Level Integration
3. UI Level Integration
4. The Manual Work-Around

Data Level Integration involves interconnecting applications through the native application data (databases), rather than through data that is exposed by an application's programming interfaces (APIs). Data level integration is conceptually very elegant; after all, the element that must be shared between applications is data, whether about customers, products, or transactions.

However, applications almost always store their data in file formats that are unique to the application; even when common file types are used, there are vast variations in how applications represent even common data elements such as names, addresses and product numbers.

Modern data translation tools will often automate the process of ensuring that data from one application is comprehensible to another or that data extracted from applications for inclusion in a central data repository is transformed into the selected universal format. However, by integrating at the data level, the elaborate checks on data integrity and synchronization of multiple data sources that are provided by application logic must be bypassed or replicated, sometimes with disastrous results. This type of integration also tends to be fragile: If the underlying data structure changes in a new version of the application, the connections between the databases have to be re-defined.

Logic Level Integration applies to the use of pre-coded APIs to expose data and functionality either directly to other programs, through object standards such as the Simple Object Access Protocol (SOAP), the Component Object Model (COM) or the Common Object Request Broker Architecture (CORBA), or indirectly through various kinds of middleware. EAI implementations are increasingly based on a hub-and-spoke model in which off-the-shelf or hand-coded adapters are used to interconnect the interfaces exposed by applications and a central broker that provides messaging services, complex data transformations, and the ability to create additional business logic to add value to the interconnected applications. While hub-and-spoke based EAI solutions are capable of supporting very high throughput and complex data transformations, they are also typically very expensive, complex, cumbersome, and brittle. All logic level integration is dependent upon coded interfaces: where those interfaces already exist, they must expose the data and functionality needed for the task at hand and where they do not already exist, they must be laboriously retrofitted by cracking open the source code of the application—almost always a difficult, time consuming, expensive, and risky prospect. This is the real Achilles heel of the Logic Level approach: often, the most mission critical systems are in-house legacy systems that do not expose the needed interfaces (APIs) and which are too important to risk retrofitting—even when source code is readily available and well-documented, which is often not the case.

One hybrid of the Data Level and Logic Level approaches that has attracted considerable attention recently is the use of eXtensible Markup Language, or XML, to share data between applications. Web services—with or without the use of SOAP—is one means of exposing XML data to other applications. XML is a document format that also incorporates metadata, or information about information, so that the data contained within an XML document is placed in a context that can ensure that different applications know how to use particular fields (for example, “customer name”). XML has been touted as a step toward universal interoperability and as a form of instant e-business integration. Even Microsoft® Corporation has jumped on the XML bandwagon and declared it to be the key component of their .NET strategy for transforming software applications into web-based services. XML will clearly play a major role in addressing the interoperability problem by providing a widely usable document format that carries the semantic information that gives data meaning. However, XML—even in conjunction with Web services and SOAP—is not a panacea. These protocols still require a means of exposing the data in the underlying application, the ability for each application to read/write XML, the need for individual industries—like the insurance industry or the Healthcare industry to agree upon standards for XML schemas, or the ability for each application to send, receive, and parse SOAP messages. All can act as important ingredients in a solution to a broad range of problems, particularly for new applications that have been architected around XML interoperability. What XML cannot do is provide enterprises with a painless way of integrating the many existing applications within their own IT shops, much less with the applications of their customers, partners and suppliers that don't support XML or support incompatible schemas.

UI Level Integration is often seen as a stopgap that adds to the difficulties of maintaining legacy applications, such as those that run on mainframe and AS/400 systems, and is prone to poor performance and fragility. Although so-called “screenscraper” technology, which intercepts and parses terminal protocols—3270 and 5250 emulators, for example—has evolved considerably since its origins several decades ago, it still can only be applied to certain terminal protocols (this list now includes HTML, though not the Java and ActiveX applets that are embedded in many web pages) and has no provision for integrating the many thousands of in-house applications that have been developed for the Windows or DOS platforms over the last twenty years. Added to these limitations is the fact that an organization has to use a separate screenscraper utility for each type of terminal-based application for which it needs to parse and integrate data, and the fact that the data is captured on the basis of its pixel coordinates on the screen. “Screenscraper” technology does not provide for capturing that data as a set of programmable objects, so if the pixel coordinates chance, the integration must be re-defined.

The Manual Work-Around is not typically included in lists of major integration methodologies. It is perhaps the most costly, though least visible, integration alternative, where manual processes bridge the gaps between applications that could not, until today, be addressed programmatically. These workarounds could be as simple (though time-consuming and tedious) as re-keying data from a report printed out by one application into the screen of another or as complex as the far more insidious case of business processes being structured inefficiently to conform to the stunted capabilities provided by existing information systems. If workers could eliminate some significant fraction of the time they lose to simply having to get information from counterparts in other parts of their own organization, information that ideally could be at their fingertips with a well-integrated information system, the potential cost savings are staggering.

What is missing from the list above is a solution that would provide the functionality of an elaborate integration-broker based EAI system without its cost and complexity or its reliance on exposed interfaces—a universal, ubiquitous programming interface. What is needed is a cost-effective, generically applicable means of automating the manual work-arounds that map business processes to existing information systems and which could serve as prototypes for the application functionality needed to carry out actual business processes.

### DESCRIPTION OF THE PRESENT SOLUTION

One of several objects of the present solution is to provide a universal programming interface for connecting, automating, and adapting packaged and legacy applications—without costly infrastructure or disruptive source-level programming.

A further object of the present solution is to provide, in contrast to expensive, long-lead solutions such as middleware or niche techniques such as screen-scraping, a consistent, broad-spectrum solution for opening software to a connected enterprise, thereby bringing applications together in real time.

The present solution uniquely satisfies the abovementioned stated objectives and further addresses the limitations of the prior art by specifically providing in accordance with the principles expressed herein, a system, machine, method and article of manufacture for non-invasively exposing windows-viewable applications at run-time and in real time, turning said applications into programmable objects to further allow said objects to be visually selected and programmatically accessed within a single object model/framework (Scene Object Model) independent of the underlying object model of the exposed application.

The Scene Object Model abstracts application user interfaces into four principal elements: a Scenes collection class, a Scene class, a Controls collection class, and a Control class. These four principal elements are presented in a hierarchical containment model that is accessed by means of a mediating component, the SceneManager. The developer can access any defined object by using standard dot notation and array/collection indexing. A Scene class represents a specific window within an application (or a specific view of the window's data). A Control represents a user interface “widget”, or region of the screen (e.g. a Button). The Scenes and Controls classes represent collections of the respective individual item classes (Scene, Control).

The following graphic shows the Scene Object Model containment hierarchy:

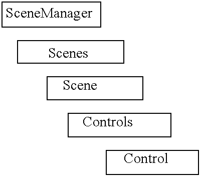

A concrete example of how the Scene Object Model provides a universal API to graphical user interfaces can be illustrated with the Excel Companion implementation set forth as Appendix D.

Excel uses the well known Spreadsheet interface comprised primarily of columns, rows and cells. It should be manifest that this interface is very different from a standard Windows form interface consisting of arbitrarily arranged textboxes, buttons and other UI widgets (TreeViews, ListBoxes, etc.)

The Excel Companion feature abstracts the Column/Row/Cell interface of Excel and exposes Excel's data through the Scene metaphor.

In Excel, an Excel Workbook, comprised of multiple Worksheets, is exposed via the Scenes collection object. An Excel Worksheet (an individual spreadsheet page within the Workbook) is exposed as a Scene object. Within the Excel Scene object, cell data or ranges of cell data are exposed as Regions (a type of Control object). The present solution uniquely identifies specific cells at runtime by means of Anchors. Anchors are design-time utility objects that are used by the present solution to relate data points (cells or ranges of cells) with some static or relative point on the Scene. Anchors are a means of unambiguously identifying a Region within the spreadsheet when either the window containing the spreadsheet is resized, or data is inserted into the spreadsheet that alters the Region's original column/row coordinates. It is also used to identify and discriminate similarly named Regions on the spreadsheet (for example, a spreadsheet may have multiple cells reflecting the Total (sum) of values contained within a range of cells (Region)). Hence, there are multiple Total values, but each is associated with some specific semantic context. Anchors can also be composited (multiple Anchors joined together) to further disambiguate the reference.

Referring more specifically to the disclosures provided herein, for illustrative purposes the present solution is embodied in the system and/or machine configuration, methods of operation, use and manufacture, and article of manufacture, product and/or computer-readable medium, such as floppy disks, conventional hard disks, CD-ROMS. Flash ROMS, nonvolatile ROM, RAM and any other equivalent computer memory device, generally shown herein and in the accompanying Appendices A-D. At this juncture the reader is urged to refer to the appendices for implementation details of the present solution bearing in mind that while the appendices describe particular embodiments of the present solution, one skilled in the art will appreciate that the present solution is not limited thereby as the disclosed embodiments of the present solution may vary as to the details without departing from the basic concepts disclosed herein.

More pointedly, unless expressly stated otherwise, all the features disclosed herein may be replaced by alternative features serving the same, equivalent or similar purpose. Therefore, numerous other embodiments of any modifications thereof are also contemplated as falling within the scope of the present solution as defined by the appended claims and equivalents thereto.

Moreover, the techniques may be implemented in hardware or software, or a combination of the two. That is, the techniques may be implemented in computer programs executing on programmable computers that each include a processor, a storage medium readable by the processor (including volatile and nonvolatile memory and/or storage elements), at least one input device and one or more output devices. Program code is applied to data entered using the input device to perform the functions described and to generate output information. The output information is applied to one or more output devices.

Each program is preferably implemented in a high level procedural or object oriented programming language to communicate with a computer system, however, the programs can be implemented in assembly or machine language, if desired. In any case, the language may be a compiled or interpreted language.

Each such computer program is preferably stored on a storage medium or device (e.g., CD-ROM, hard disk or magnetic diskette) that is readable by a general or special purpose programmable computer for configuring and operating the computer when the storage medium or device is read by the computer to perform the procedures described in this document. The present solution may be implemented as a computer-readable storage medium, configured with a computer program, where the storage medium so configured causes a computer to operate in a specific and predefined manner.

Among other advantages, the present solution facilitates application integration—applications may be built using the present solution that exchange data between two or more applications; application enhancement—a new front-end for an existing application may created using the present solution in order to improve its usability; automation of user activities—applications may built using the present solution that access and use other applications through the UI, thus automating common user activities such as data aggregation; development of data access applications—universal adapter to multiple applications or data sources may be created using the present solution; development of composite applications—applications may be integrated using the present solution to gain a unified view of data within a single interface, such as a Web page or an executive dashboard; web services—legacy functionality may be exposed as web services for use by other applications; enterprise applications extension—the present solution enables subsets of enterprise application functionality to be exposed to mobile professionals without the need to re-engineer legacy enterprise applications: retrofitting of API's—existing API's may be retrofitted using the present solution.

What is claimed is:

1. A system substantially as described hereinabove.

2. A method substantially as described hereinabove.
